(19) United States
(12) Patent Application Publication
(10) Pub. No.: US 2017/0148342 A1
(43) Pub. Date: May 25, 2017

(54) SYSTEM AND METHOD TO ESTABLISH ACCOUNTABILITY AND REWARDS

(71) Applicants: Patrick Jude Barry, Los Angeles, CA (US); David Anthony William Shaw, Los Angeles, CA (US)

(72) Inventors: Patrick Jude Barry, Los Angeles, CA (US); David Anthony William Shaw, Los Angeles, CA (US)

(21) Appl. No.: 14/951,423

(22) Filed: Nov. 24, 2015

(51) Int. Cl. G09B 19/00; G06Q 50/00; G06Q 20/10

(52) U.S. Cl. CPC G09B 19/00; G06Q 20/10; G06Q 50/01

(57) ABSTRACT

The present invention provides a system and a method comprising a graphical user interface and delivered via the Internet and/or a mobile, tablet or wearable device, that articulate, establish, monitor and enforce a commitment contract between two parties by making visible the upfront/advance terms for users in a defined group to participate in and complete an action, activity and/or event, by notating agreed upon financial and/or non-financial penalties relating to such commitments, by tracking a user's adherence to such commitments, by conducting rebate/reward accounting, if applicable, and by conducting penalty accounting, if applicable. Further, the system and the method disclosed herein conduct accounting of financial and/or non-financial penalties, if applicable, that accumulate as surplus rewards as a result of non-commitment adherence by users, which then may or may not be distributed to all users in the defined group or a subset of users in the defined group based on a set of predetermined criteria.

### FIELD OF THE INVENTION

The present invention relates generally to motivating people to achieve a goal. The present invention is more particularly directed to a system and a method comprising group behavior and online social networking-based accountability and rewards mechanism to motivate people.

### BACKGROUND OF THE INVENTION

Most people don't often do what they intend to do or commit to do. The gap between ‘I should’, ‘I will’ or ‘I promise to’, compared to the actual completion is often wide. Despite intent, completed action is not always the end result and the final outcome. Whether it's attending a group fitness class three times per week, jogging on the treadmill for thirty minutes every other day, fast-walking around the block before the workday, attending a weekly book club meeting, or keeping the weekly appointment for Poker Night, people often don't do what they intended and/or agreed to do, reinforcing that the very human gap between intention and completion exists for virtually everyone.

Several solutions have been proposed in prior art to solve this problem by offering motivation through various channels to bridge this gap. However, none of these solutions are as effective as the solution proposed in the present application, reasons for which will be apparent to those skilled in the art upon going through the description of the present invention as presented henceforth.

### SUMMARY OF THE INVENTION

The present application provides a system and a method comprising a graphical user interface and delivered via the Internet and/or a mobile, tablet or wearable device, that articulate, establish, monitor and enforce a commitment contract between two parties. Each of the two parties may comprise users, where users may include, but is not limited to, standalone individuals, individuals within a network, group or associations of individuals, business organizations, non-profit organizations, random groupings, or any combination thereof whether formal or informal and whether commercial or non-commercial. The commitment contract is articulated, established, monitored and enforced by making visible the upfront/advance terms for users in at least one of the two parties to participate in and complete an action, activity and/or event, by notating agreed upon financial and/or non-financial penalties relating to such commitments, by tracking users' adherence to such commitments, by conducting rebate/reward accounting, if applicable, and by conducting penalty accounting, if applicable. Further, the system and the method disclosed herein conduct accounting of monetary and/or non-monetary penalties, if applicable, that accumulate as surplus rewards as a result of non-commitment adherence by users, which then may or may not be distributed to one or more of the users based on a set of predetermined criteria.

As per another embodiment, the system and the method of the present invention allow any number of users in a defined group to make commitments among each other, to view, monitor and track adherence to such commitments, to conduct accounting of monetary rebates/rewards based on adherence to commitments, to conduct accounting of monetary and/or non-monetary penalties based on non-adherence to commitments, and to conduct accounting for the accumulation of surplus monetary and/or non-monetary rebates/rewards, resulting from the users' non-adherence to commitments, for possible distribution to all users in the defined group or to a subset of users in the defined group based on a set of pre-determined criteria.

Users in a defined group can be standalone individuals, individuals within a network, group or associations of individuals, business organizations, non-profit organizations, random groupings, or any combination thereof whether formal or informal and whether commercial or non-commercial. Further, terms of a commitment to adhere to which is made visible by the system and the method of the present invention may include, but is not limited to, a pre-determined length of a commitment, number of actions/activities/events contained within the pre-determined length of the commitment, a monetary value of each action/activity/event within the commitment, a monetary rebate/reward associated with each action/activity/event, a monetary or non-monetary penalty associated with each action/activity/event, and other applicable rules and regulations pre-defined by and/or for a defined group of users involved in the commitment and agreed upon by the defined group of users.

### DESCRIPTION OF THE DRAWINGS

FIG. 1 illustrates a flow diagram of a method to establish accountability and award rewards in accordance with an embodiment of the present invention.

FIG. 2 illustrates an exemplary, non-limiting screen-shot of a graphical user interface delivering the method to establish accountability and award rewards in accordance with an embodiment of the present invention.

FIG. 3 illustrates another exemplary, non-limiting screen-shot of a graphical user interface delivering the method to establish accountability and award rewards in accordance with an embodiment of the present invention.

FIG. 4 illustrates yet another exemplary, non-limiting screen-shot of a graphical user interface delivering the method to establish accountability and award rewards in accordance with an embodiment of the present invention.

FIG. 5 illustrates a flow diagram of a method to establish accountability and award rewards in accordance with another embodiment of the present invention.

### DETAILED DESCRIPTION OF THE INVENTION

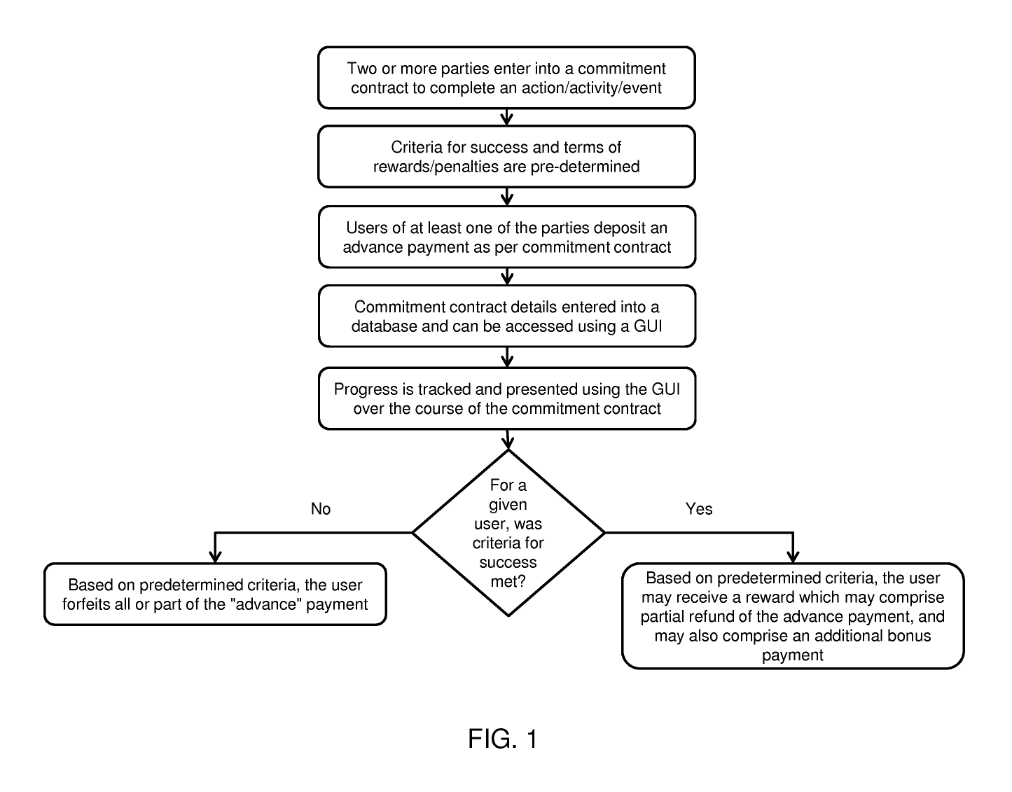

Construction and working of a system and a method to establish accountability and award rewards as per the present invention has been explained henceforth using exemplary non-limiting embodiments of the present invention with reference to FIGS. 1, 2, 3, 4 and 5.

In order to motivate or prompt engagement with, attendance at, participation in or completion of an action, activity and/or event, individuals are often motivated by extrinsic factors. The system and the method of the present invention in the form of a graphical user interface delivered via the Internet and/or mobile, tablet or wearable device herein have application in varied activities, actions and/or events for users in a defined group or groups of users in a defined group, which may include, but is not limited to, fitness classes, athletic league practices, book clubs, weekly poker games, choir rehearsals, work assignments, study groups, volunteer tasks, weekly chores and other actions, appointments, activities or events that users or groups of users wish to commit to or actually commit to in advance with the ultimate intent to arrive at completion.

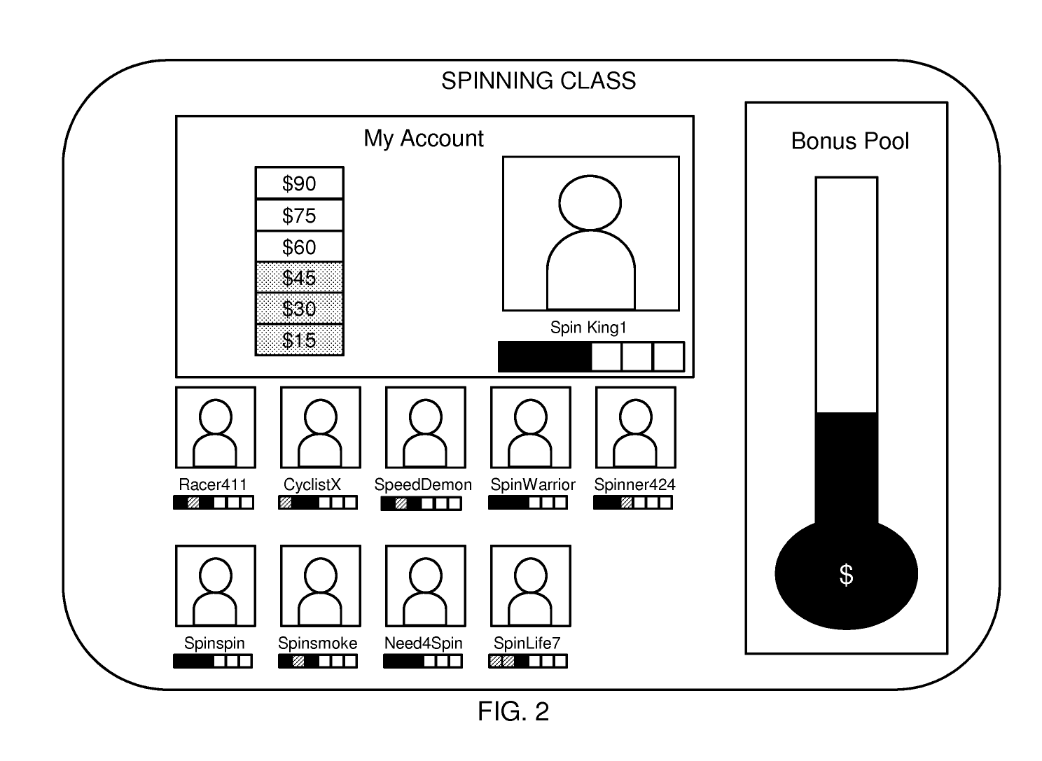

As per an embodiment of the present invention, extrinsic motivation in the form of both potential penalty and potential reward involves user attendance at an organized group fitness class such as yoga, indoor cycling (also known as Spinning@), or boot camp. FIG. 2 illustrates an exemplary, non-limiting Spinning group. FIG. 1 illustrates an exemplary simplistic workflow of the method of the present invention applicable to this embodiment. Users individually visit a pre-determined online or mobile app destination via the Internet or via their mobile, tablet or wearable device and log-in to a unique account that thereafter contains the user's unique profile information. Upon visitation, the user enrolls in and agrees to a commitment level for attendance for an assigned period of time, an accompanying cost of attendance paid in advance, and any applicable rebates that may occur for adhering to attendance commitments. The user is also able to view on an ongoing basis his or her class attendance records, the class attendance records of individuals within the group, the overall group's attendance record, individual rebates due to individual's adherence to attendance commitments, and the collective sum of financial forfeitures, if any, that may occur and accumulate as group financial rewards due to users' non-adherence to attendance commitments. Such group financial rewards may or may not be distributed to all users or to a subset of users based on pre-determined criteria. Plainly stated, in a financial penalty and reward example, a user who agrees to but does not attend a particular class forfeits the entirety of his or her advance money paid for that particular class, while the user who agrees to and does attend that particular class receives a rebate. All forfeited money is pooled until the end of a pre-determined number of classes, and then is distributed in part or in whole to all or a subset of the class members as per predetermined criteria.

As per another embodiment of the present invention, extrinsic motivation in the form of potential penalty and potential reward involves user attendance at an organized group activity such as adult league hockey team practice. FIG. 1 illustrates an exemplary simplistic workflow of the method of the present invention applicable to this embodiment. Users individually visit a pre-determined online or mobile app destination for their team via the Internet or via their mobile, tablet or wearable device and log-in to a unique account that thereafter contains the user's unique profile information. Upon visitation, the user enrolls in and agrees to a commitment level for attendance to team practices for an assigned period of time, agrees to a financial value of each attendance to practices that is to be paid in advance, and agrees to a rebate amount that occurs for adhering to attendance commitments for each practice. The user is also able to view on an ongoing basis his or her practice attendance records, the practice attendance records of other individuals on the team, the overall team's practice attendance record, his or her rebates due to adherence to practice attendance commitments, the collective sum of financial forfeitures, if any, that may occur and accumulate as group financial rewards due to users' non-adherence to practice attendance commitments, and the collective sum of financial forfeitures, if any, that may occur and accumulate as group financial rewards due to users' non-adherence to practice attendance commitments. Such group financial rewards may or may not be distributed to all users or to a subset of users based on pre-determined criteria. Plainly stated, in a financial penalty and reward example, a user who agrees to but does not attend practice forfeits the entirety of his or her advance money paid for that practice. All forfeited money is pooled until the end of a pre-determined number of practices, and then is distributed in part or in whole to all or a subset of the team members as per predetermined criteria, or utilized for a collective team activity or need.

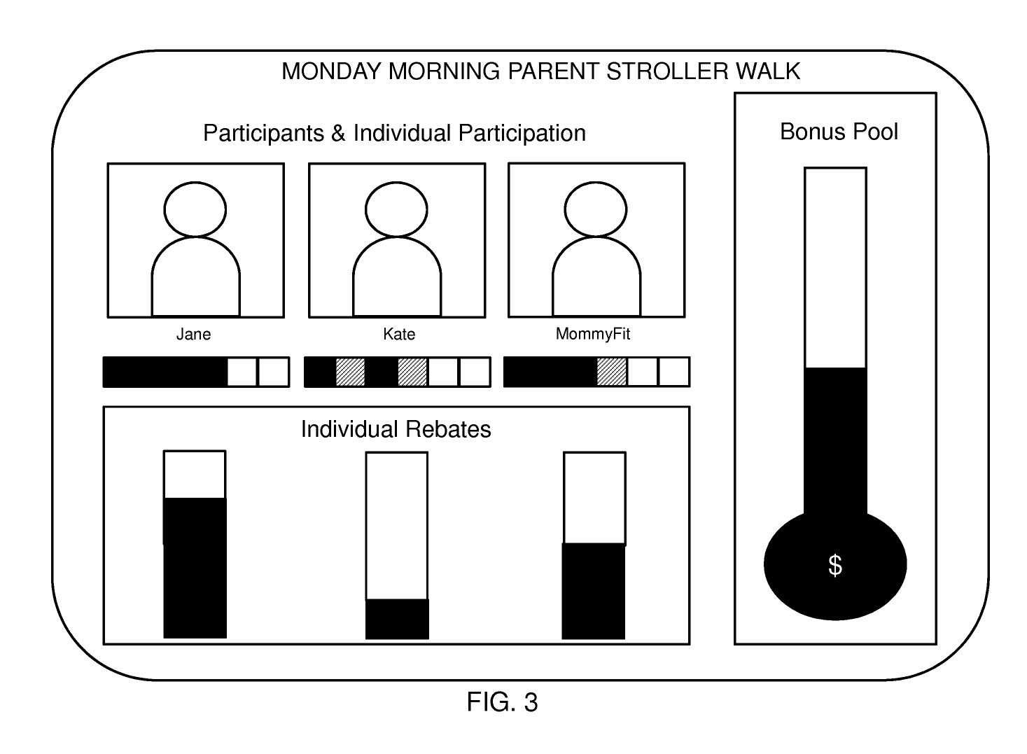

As per yet another embodiment of the present invention, extrinsic motivation in the form of potential penalty and potential reward involves user attendance at an organized group activity such as Monday Morning Neighborhood Parent Stroller Walk, as illustrated in FIG. 3. FIG. 1 illustrates an exemplary simplistic workflow of the method of the present invention applicable to this embodiment. Users individually visit a pre-determined online or mobile app destination for their weekly group activity via the Internet or via their mobile, tablet or wearable device and log-in to a unique account that contains the user's unique profile information. Upon visitation, the user views his or her agreed upon commitment level for attendance as well as his or her action, activity or event attendance record for an assigned period of time. The user is also able to view on an ongoing basis his or her attendance records, the attendance records of other individuals in the group, the overall group's attendance record, his or her rebates due to adherence to attendance commitments, the collective sum of financial forfeitures, if any, that may occur and accumulate as group financial and/or or non-financial rewards due to users' non-adherence to attendance commitments, and the collective sum of financial forfeitures, if any, that may occur and accumulate as group financial and/or non-financial rewards due to users' non-adherence to attendance commitments. Such group financial and/or non-financial rewards may or may not be distributed to all users or to a subset of users based on pre-determined criteria. Plainly stated, in a hybrid example comprised of both financial and non-financial penalties and financial and non-financial rewards, a user who agrees to but does not attend a Monday Morning Neighborhood Parent Stroller Walk forfeits the entirety of his or her advance money paid for that Monday Morning's Walk. All forfeited money is pooled until the end of a pre-determined number of Monday Morning Walks, and then is distributed in part or in whole to all or a subset of the group members as per predetermined criteria, or utilized for a collective group activity or need.

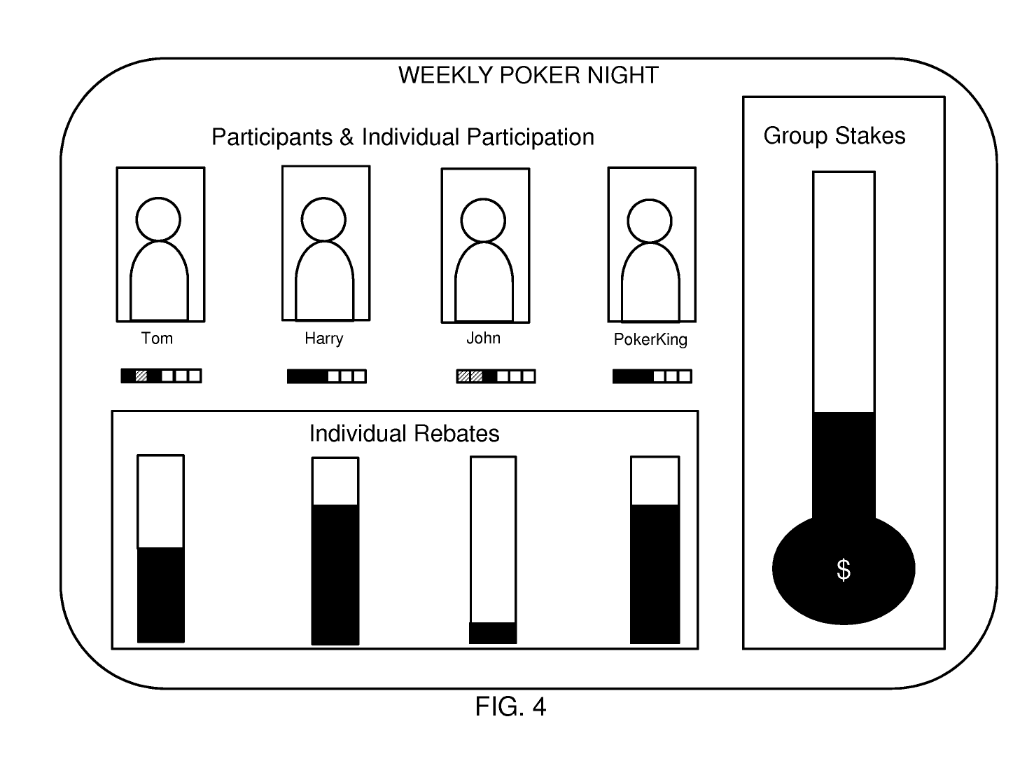

As per yet another embodiment of the present invention, extrinsic motivation in the form of potential penalty and potential reward involves user attendance at an organized group activity such as Weekly Poker Night, as illustrated in FIG. 4. FIG. 1 illustrates an exemplary simplistic workflow of the method of the present invention applicable to this embodiment. Users individually visit a pre-determined online or mobile app destination for their weekly group activity via the Internet or via their mobile, tablet or wearable device and log-in to a unique account that contains the user's unique profile information. Upon visitation, the user views his or her agreed upon commitment level for attendance as well as his or her action, activity or event attendance record for an assigned period of time. The user is also able to view on an ongoing basis his or her attendance records, the attendance records of other individuals in the group, the overall group's attendance record, his or her rebates due to adherence to attendance commitments, the collective sum of financial forfeitures, if any, that may occur and accumulate as group financial rewards due to users' non-adherence to attendance commitments. Such group financial rewards may or may not be distributed to all users or to a subset of users based on pre-determined criteria. Plainly stated, in a financial penalty and reward example, a user who agrees to but does not attend Weekly Poker Night forfeits the entirety of his or her advance money paid for that night. All forfeited money is pooled until the end of a pre-determined number of Weekly Poker Nights, and then is distributed in part or in whole to all or a subset of the poker players as per predetermined criteria, or utilized for a collective group activity or need.

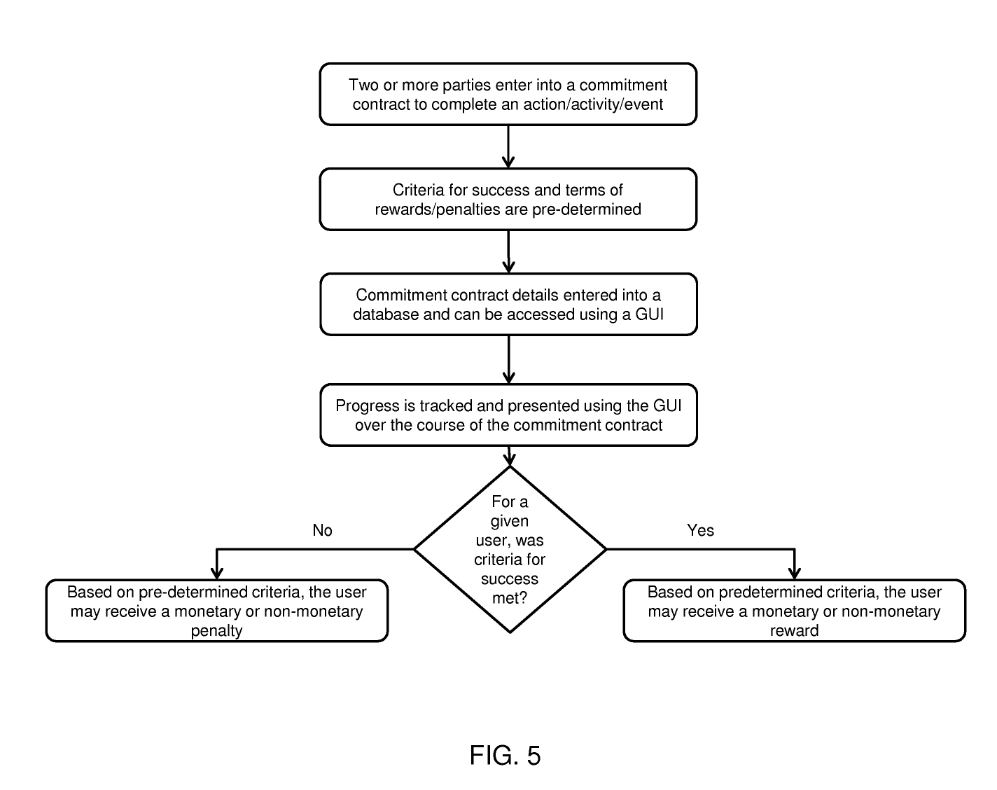

As per yet another embodiment of the present invention, extrinsic motivation in the form of non-monetary potential penalty and non-monetary potential reward involves user attendance at an organized group activity such as a Weekly Extreme Exercise Activity. FIG. 5 illustrates an exemplary simplistic workflow of the method of the present invention applicable to this embodiment. Users individually visit a pre-determined online or mobile app destination for their weekly group activity via the Internet or via their mobile, tablet or wearable device and log-in to a unique account that contains the user's unique profile information. Upon visitation, the user views his or her agreed upon commitment level for attendance as well as his or her action, activity or event attendance record for an assigned period of time. The user is also able to view on an ongoing basis his or her attendance records, the attendance records of other individuals in the group, the overall group's attendance record, his or her non-monetary rewards and/or non-monetary penalty due to adherence or non-adherence to the attendance commitments. For example, a user who agrees to but does not attend a Weekly Extreme Exercise Activity might be penalized upon attending the next event by having to perform an extra set of extreme exercise or by having to perform a pre-determined set of additional exercises as a penalty. As another example, attendance of all the users in the group activity may be accounted for at the end of a pre-determined number of sessions and thereafter, based on a set of pre-determined rules for non-monetary potential penalty and non-monetary potential reward, each user of the group activity might be rewarded or penalized, individually. In this case, an example of a penalty might be that a penalized user will have to perform some chores for a rewarded user. As per another embodiment of the present invention, a user deemed the “winner” of the extreme exercise event may also receive a monetary reward where the monetary reward could be an agreed upon financial sum pooled by the rest of the users of the group. It will be apparent to those skilled in the art that this methodology incentivizes and motivates users of the group to perform better in pursuit of the reward.

As can be clearly understood from the description above, the system and the method of the present invention offers the following advantages:
1. Group dynamics that foster competition, encouragement, and visible accountability
2. Extrinsic motivation to avoid penalties
3. Extrinsic motivation to win rewards
4. Penalty accounting
5. Reward accounting

Further, due to continuous tracking and updates using the graphical user interface ensures that there is no scope for unfair practices and everyone can fully trust the system while keeping themselves motivated to achieve their intended and agreed upon outcomes based on the progress of other group members in a group activity.

Various modifications to the above described invention will be readily apparent to those skilled in the art and the general principles defined herein may be applied to other embodiments and applications without departing from the spirit and scope of the present invention. Thus, the present invention is not intended to be limited to the embodiments described, but is to be accorded the widest scope consistent with the principles and features disclosed herein. Therefore, the scope of the invention is to be determined by the terminology of the above description and the legal equivalents thereof.

What is claimed is:

1. A method for motivating each user in a pre-defined group of users for completing a task, wherein the completion of the task comprises completing a set of activities within a pre-determined time period, said method comprising:
each user agreeing to a pre-determined commitment level and associated rules for rewards and penalties applicable to the entire pre-defined group of users;
each user depositing in advance a pre-determined monetary value corresponding to the entire set of activities in a common monetary pool for the pre-defined group of users;
tracking progress of each user towards achieving the agreed upon and pre-determined commitment level on a regular basis;
conducting accounting of rewards or penalties for each user on a regular basis based on each user's tracked progress; and
awarding rewards or penalties to each user upon completion of the task by using the common monetary pool, wherein the rewards or penalties will motivate each user to perform better.

2. The method of claim 1, wherein the progress of each user is tracked by calculating the number of activities completed by each user out of the set of activities.

3. The method of claim 2, wherein the pre-determined monetary value required to be deposited in advance by each user is calculated using a sum total of a pre-determined monetary value for each activity from the set of activities.

4. The method of claim 3 further comprising, conducting accounting of rewards by offering back a pre-determined monetary value from the advance deposit based on each user's tracked progress.

5. The method of claim 4 further comprising, conducting accounting of penalties by withholding a pre-determined monetary value from the advance deposit based on each user's tracked progress.

6. The method of claim 5 further comprising, awarding penalties upon completion of the task by withholding a pre-determined monetary value from the advance deposit based on the total number of activities completed by each user out of the set of activities.

7. The method of claim 6, wherein a pre-determined portion of the total withheld pre-determined monetary value from each user will be deposited in a common bonus pool.

8. The method of claim 7 further comprising, awarding rewards upon completion of the task by distributing all or a portion of entire monetary value of the common bonus pool.

9. A method for motivating each user in a pre-defined group of users for completing a task, wherein the completion of the task comprises completing a set of activities within a pre-determined time period, said method comprising:
each user agreeing to a pre-determined commitment level and associated rules for rewards and penalties applicable to the entire pre-defined group of users, wherein the rewards and the penalties are non-monetary in nature;
tracking progress of each user towards achieving the agreed upon and pre-determined commitment level on a regular basis;
conducting accounting of rewards or penalties for each user on a regular basis based on each user's tracked progress; and
awarding rewards or penalties to each user upon completion of the task, wherein the rewards or penalties will motivate each user to perform better.

10. The method of claim 9, further comprising awarding rewards or penalties to each user on a regular basis upon completion of each activity from the set of activities to complete the task based on the user's adherence to the pre-determined commitment level, wherein the rewards or penalties will motivate each user to perform better.

11. A method for motivating each user in a pre-defined group of users for completing a task, wherein the completion of the task comprises completing a set of activities within a pre-determined time period, said method comprising:
each user agreeing to a pre-determined commitment level and associated rules for rewards and penalties applicable to the entire pre-defined group of users;
tracking progress of each user towards achieving the agreed upon and pre-determined commitment level on a regular basis;
conducting accounting of rewards or penalties for each user on a regular basis based on each user's tracked progress; and
awarding rewards or penalties to each user upon completion of the task, wherein the rewards or penalties will motivate each user to perform better.

12. The method of claim 11, further comprising awarding rewards or penalties to each user on a regular basis upon completion of each activity from the set of activities to complete the task based on the user's adherence to the pre-determined commitment level, wherein the rewards or penalties will motivate each user to perform better.

13. The method of claim 11, wherein the rewards or the penalties are of monetary nature.

14. The method of claim 11, wherein the rewards or the penalties are of non-monetary nature.

15. The method of claim 11, wherein the rewards or the penalties are of monetary as well as non-monetary nature.
